(19) United States
(12) Patent Application Publication
(10) Pub. No.: US 2022/0052995 A1
(43) Pub. Date: Feb. 17, 2022

(54) CONTROLLING THE ACCESS TO AN ASSET BY A SINGLE DEVICE FOR DIFFERENT USERS

(71) Applicant: ARRIS Enterprises LLC, Suwanee, GA (US)

(72) Inventors: Lokesh LINGAIAH, Bangalore (IN); Santhosha DEVASYA, Bangalore (IN); Manjunatha NARASIMHAMURTHY, Bangalore (IN)

(21) Appl. No.: 17/232,415

(22) Filed: Apr. 16, 2021

Related U.S. Application Data
(60) Provisional application No. 63/065,811, filed on Aug. 14, 2020.

(51) Int. Cl. H04L 29/06; H04W 76/10; H04L 29/08; H04W 12/08

(52) U.S. Cl. CPC H04L 63/0861; H04W 12/08; H04L 67/146; H04W 76/10

(57) ABSTRACT

Access control to one or more assets by an access point device to a client device utilizing an asset control function of the access point device that determines access to one or more assets attempting to be accessed by any one or more users of a client device is provided. In addition, there is provided a centralized repository to store and/or maintain information and/or data for use by the asset control function where the centralized repository can be local to or remote from the access point device. The novel solutions according to example embodiments of inventive concepts disclosed herein provide features that enhance the network environment of, for example, a home/residential network gateway, wireless access points, Home Network Controller, wireless routers, mesh networking nodes (e.g., Wi-Fi EasyMesh systems), and the like, by providing access control to one or more assets based on the user of the client device.

### BACKGROUND

Companies are increasingly providing Multiple Access Point (MAP) architecture or Home Network Controller (HNC) type of home Wi-Fi management, with multiple access point devices and/or extender access point devices within the home to improve Quality of Experience (QoE) of the user for various client devices by offering extended coverage with seamless roaming. Access point devices and extender access point devices communicate with client devices using one or more RF channels.

Configuration of home network access point devices and/or extender access point devices is increasingly requiring additional features and configurations to provide an enjoyable, controllable, and safe QoE. Increasingly, users are requesting configurable access control for controlling access to assets that are permitted to be consumed by any number of users using a variety of client devices connected to the network, for example, via an access point device, such as a residential gateway.

Many customers often experience a problem with controlling access to various assets due to the complexity of the network, the multiple users using the same client device, and/or the number and multiple types of client devices that connect to the network on a daily or even hourly basis. Typically, to resolve this problem, systems or programs that control access to various assets by a given client device must be installed at or operated from each individual client device that connects to the network. Such requires extensive monitoring to ensure that each individual client device conforms to the desired access controls.

Therefore, there is a need to provide improved access controls for the various client devices that connect to a network. Such an improvement will significantly enhance the QoE of a user as such will reduce the required monitoring and configuration of each individual client device.

### SUMMARY

According to aspects of the present disclosure there are provided novel solutions for dynamically controlling access to various assets, for example, content, by any number of different users associated with a specific client device or various client devices. For example, if a client device with a media access control (MAC) address is configured to allow access to the Internet then typically any user of the client device may be able to browse any content on the Internet irrespective of the user. The provided novel solutions include a centralized approach to control access to assets by multiple users of each individual client device connected to the network without the need to configure a separate profile on every client device for each user of the client device which increases the efficiency and costs associated with configuring the network and connected electronic devices. The aspects of the present disclosure provide features that enhance the control of access to assets by using a centralized asset control function, which may be incorporated into one or more access point devices (for example, home/residential network access point devices, wireless extender access point devices (Wi-Fi APs), Home Network Controller devices, wireless routers, mesh networking nodes (e.g., Wi-Fi EasyMesh systems), and the like.

An aspect of the present disclosure provides an access point device for use with a client device for providing access control to the client device. The access point device comprises a memory storing one or more computer-readable instructions, and a process configured to execute the one or more computer-readable instructions to establish a connection with the client device, receive an access request from the client device for access to an asset, request, from the client device, a user scan of a user of the client device, perform an access control function based, at least in part, on the user scan and the access request to determine an access control parameter, and provide access control to the client device for the asset based, at least in part, on the access control parameter.

In an aspect of the present disclosure, the processor is further configured to execute the one or more computer-readable instructions to store one or more user identifiers in a central repository, wherein at least one of the one or more user identifiers is associated with the user.

In an aspect of the present disclosure, the performing the access control function comprises identifying a user match by comparing the user scan to one or more user identifiers in a central repository and determining the access control parameter based, at least in part, on comparing one or more user identifiers associated with the user match and one or more asset parameters associated with the asset.

In an aspect of the present disclosure, the one or more user identifiers comprise one or more user attributes, and wherein the one or more user attributes comprise any of a user age, a user date range, a user time range, or a combination thereof and the one or more asset parameters comprise one or more asset attributes, and wherein the one or more asset attributes comprise any of an asset age, an asset date range, an asset time range, or a combination thereof.

In an aspect of the present disclosure, the one or more user attributes is the user age of the user, the asset is the content associated with an Internet uniform resource locator (URL) and the one or more asset attributes is the asset age and the comparing the one or more user identifiers associated with the user match and the one or more asset parameters associated with the asset comprises determining if the user age is at, above or both the asset age.

In an aspect of the present disclosure, the providing access control comprises blocking the client device from accessing the asset or allowing the client device to access the asset.

In an aspect of the present disclosure, the user scan comprises any of a facial pattern scan, a thumbprint scan, a retinal scan, an iris scan or a combination thereof.

An aspect of the present disclosure provides a method for an access point device to provide access control to a client device. The method can include establishing a connection with the client device, receiving an access request from the client device for access to an asset, requesting, from the client device, a user scan of a user of the client device, performing an access control function based, at least in part, on the user scan and the access request to determine an access control parameter, and providing access control to the client device for the asset based, at least in part, on the access control parameter.

In an aspect of the present disclosure, the method further comprises storing one or more user identifiers in a central repository, wherein at least one of the one or more user identifiers is associated with the user.

In an aspect of the present disclosure, the performing the access control function comprises identifying a user match by comparing the user scan to one or more user identifiers in a central repository and determining the access control parameter based, at least in part, on comparing one or more user identifiers associated with the user match and one or more asset parameters associated with the asset.

In an aspect of the present disclosure, the one or more user identifiers comprise one or more user attributes, and wherein the one or more user attributes comprise any of a user age, a user date range, a user time range, or a combination thereof and the one or more asset parameters comprise one or more asset attributes, and wherein the one or more asset attributes comprise any of an asset age, an asset date range, an asset time range, or a combination thereof.

In an aspect of the present disclosure, the one or more user attributes is the user age of the user, the asset is the content associated with an Internet uniform resource locator (URL) and the one or more asset attributes is the asset age and the comparing the one or more user identifiers associated with the user match and the one or more asset parameters associated with the asset comprises determining if the user age is at, above or both the asset age.

In an aspect of the present disclosure, the providing access control comprises blocking the client device from accessing the asset or allowing the client device to access the asset.

In an aspect of the present disclosure, the user scan comprises any of a facial patter, a thumbprint, a retinal scan, an iris scan, or a combination thereof.

An aspect of the present disclosure provides a non-transitory computer-readable medium of an access control device for storing a program to provide access control to a client device. The program when executed by a processor of the access control device, causes the access point device to perform one or more operations including the steps of the methods described above.

The above-described novel solution may be implemented at an access point device of a network, such as a residential gateway, according to one or more example embodiments.

Thus, according to various aspects of the present disclosure described herein, it is possible to provide a centralized access control for any number of users of various client devices connected to a network. The novel solution described herein addresses the problem of having to continuously monitor and configure various client devices that connect and/or are already connected to the network. In particular, the novel solution provides improvements for controlling access to an asset by a particular user of a client device over a network utilizing a centralized access control function.

### BRIEF DESCRIPTION OF DRAWINGS

In the drawings, like reference numbers generally indicate identical, functionally similar, and/or structurally similar elements.

FIG. 1 is a schematic diagram of a system, according to one or more embodiments of the present disclosure;

FIG. 2 is a more detailed block diagram illustrating various components of an exemplary access point device, client device, and extender access point device implemented in the system of FIG. 1, according to one or more embodiments of the present disclosure;

FIG. 3 is a more detailed block diagram illustrating certain components of an exemplary access point device implemented in the system of FIGS. 1-2, according to one or embodiments of the present disclosure;

FIG. 4 is a detailed block diagram of a central repository for storing one or more elements used by an access control function, according to an embodiment of the present disclosure;

FIGS. 5A and 5B are detailed block diagrams of an access control system, according to one or more embodiments of the present disclosure; and

FIG. 6 is a flow chart illustrating a method for providing at an access point device access control of an asset by a user of a client device, according to one or embodiments of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

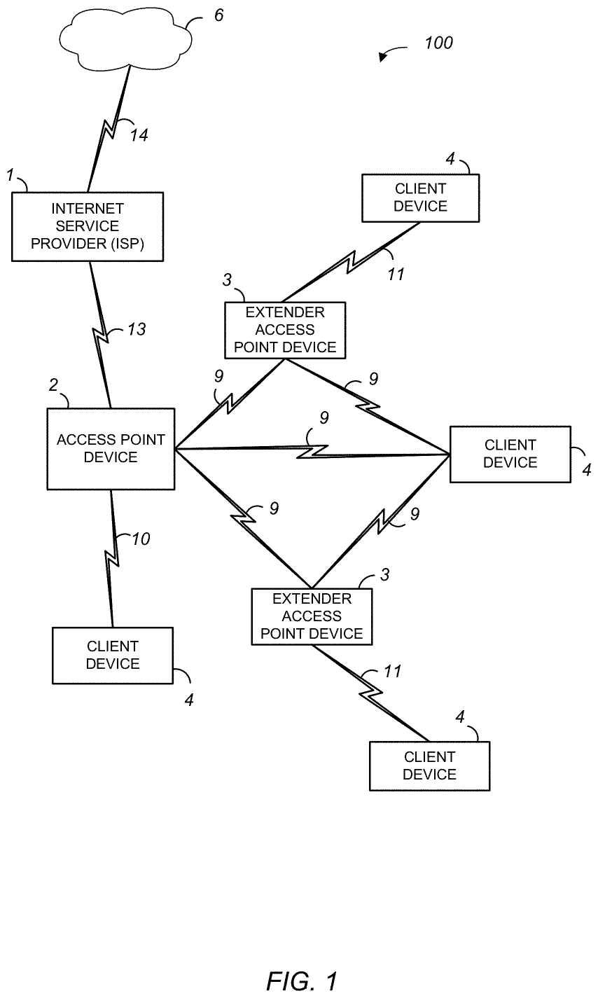

FIG. 1 is a schematic diagram of a system, according to one or more example embodiments.

It should be appreciated that various example embodiments of inventive concepts disclosed herein are not limited to specific numbers or combinations of devices, and there may be one or multiple of some of the aforementioned electronic apparatuses in the system, which may itself consist of multiple communication networks and various known or future developed wireless connectivity technologies, protocols, devices, and the like.

As shown in FIG. 1, the main elements of the system 100 include an access point device 2 connected to the Internet 6 via an Internet Service Provider (ISP) 1 and also connected to different wireless devices such as one or more wireless extender access point devices 3 and one or more client devices 4. The system 100 shown in FIG. 1 includes wireless devices (e.g., extender access point devices 3 and client devices 4) that may be connected in one or more wireless networks (e.g., private, guest, iControl, backhaul network, or Internet of things (IoT) network) within the system 100. Additionally, there could be some overlap between wireless devices (e.g., extender access point devices 3 and client devices 4) in the different networks. That is, one or more network or wireless devices could be located in more than one network. For example, the extender access point devices 3 could be located both in a private network for providing content and information to a client device 4 and also included in a backhaul network or an iControl network.

Starting from the top of FIG. 1, the ISP 1 can be, for example, a streaming video provider or any computer for connecting the access point device 2 to the Internet 6 for access to an asset. An asset can include, but is not limited to, any of an application, a program, a login, a directory, a file structure, a device setting and/or configuration, data, content (for example, audio content, video content, and/or audio/video content), any other information received from ISP 1, or a combination thereof. The connection 14 between the Internet 6 and the ISP 1 and the connection 13 between the ISP 1 and the access point device 2 can be implemented using a wide area network (WAN), a virtual private network (VPN), a metropolitan area networks (MAN), a system area networks (SAN), a data over cable service interface specification (DOCSIS) network, a fiber optics network (e.g., FTTH (fiber to the home) or FTTX (fiber to the x), or a hybrid fiber-coaxial (HFC)), a digital subscriber line (DSL), a public switched data network (PSDN), a global Telex network, or a 2G, 3G, 4G, 5G, or 6G network, for example.

The connection 13 can further include as some portion thereof a broadband mobile phone network connection, an optical network connection, or other similar connections. For example, the connection 13 can also be implemented using a fixed wireless connection that operates in accordance with, but is not limited to, 3rd Generation Partnership Project (3GPP) Long Term Evolution (LTE), 5G, or 6G protocols. It is also contemplated by the present disclosure that connection 13 is capable of providing connections between the access point device 2 and a WAN, a LAN, a VPN, MANs, PANs, WLANs, SANs, a DOCSIS network, a fiber optics network (e.g., FTTH, FTTX, or HFC), a PSDN, a global Telex network, or a 2G, 3G, 4G, 5G or 6G network, for example.

The access point device 2 can be, for example, an access point and/or a hardware electronic device that may be a combination modem and gateway, such as a residential gateway, that combines the functions of a modem, an access point (AP), and/or a router for providing content received from the content provider 1 to network devices (e.g., wireless extender access point devices 3 and client devices 4) in the system 100. It is also contemplated by the present disclosure that the access point device 2 can include the function of, but is not limited to, an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content. The access point device 2 may also be referred to as a residential gateway, a home network gateway, or a wireless access point (AP). Further, an access point device 2 can be an electronic device that includes an application or software that utilizes an access control function for controlling access to an asset by a user of a client device 3 as described with reference to, for example, FIGS. 3, 4, 5A, 5B and 6.

The connection 9 between the access point device 2, the wireless extender access point devices 3, and client devices 4 can be implemented using a wireless connection in accordance with any IEEE 802.11 Wi-Fi protocols, Bluetooth protocols, BLE, or other short range protocols that operate in accordance with a wireless technology standard for exchanging data over short distances using any licensed or unlicensed band such as the citizens broadband radio service (CBRS) band, 2.4 GHz bands, 5 GHz bands, 6 GHz, or 60 GHz bands. Additionally, the connection 9 can be implemented using a wireless connection that operates in accordance with, but is not limited to, RF4CE protocol, ZigBee protocol, Z-Wave protocol, or IEEE 802.15.4 protocol. It is also contemplated by the present disclosure that the connection 9 can include connections to a media over coax (MoCA) network. One or more of the connections 9 can also be a wired Ethernet connection. Any one or more of connections 9 can carry information associated with an asset.

The extender access point devices 3 can be, for example, wireless hardware electronic devices such as access points (APs), extenders, repeaters, etc. used to extend the wireless network by receiving the signals transmitted by the access point device 2 and rebroadcasting the signals to, for example, client devices 4, which may out of range of the access point device 2. The extender access point devices 3 can also receive signals from the client devices 4 and rebroadcast the signals to the access point device 2, or other client devices 4.

The connection 11 between the extender access point devices 3 and the client devices 4 are implemented through a wireless connection that operates in accordance with any IEEE 802.11 Wi-Fi protocols, Bluetooth protocols, BLE, or other short range protocols that operate in accordance with a wireless technology standard for exchanging data over short distances using any licensed or unlicensed band such as the CBRS band, 2.4 GHz bands, 5 GHz bands, 6 GHz, or 60 GHz bands. Additionally, the connection 11 can be implemented using a wireless connection that operates in accordance with, but is not limited to, RF4CE protocol, ZigBee protocol, Z-Wave protocol, or IEEE 802.15.4 protocol. Also, one or more of the connections 11 can be a wired Ethernet connection. Any one or more connections 11 can carry information associated with an asset.

The client devices 4 can be, for example, hand-held computing devices, personal computers including, but not limited to, any of a desktop computer or a laptop, an electronic tablet, a mobile phone, a smart phone, a smart speaker, an IoT device, an iControl device, a portable music player with smart capabilities capable of connecting to the Internet, a cellular network, and/or interconnecting with other devices via Wi-Fi and/or Bluetooth, other wireless hand-held consumer electronic devices capable of executing and displaying information, for example, content, associated with an asset received through the access point device 2, or any combination thereof. Additionally, the client devices 4 can be a television (TV), an IP/QAM set-top box (STB) or a streaming media decoder (SMD) that is capable of decoding audio/video content, and playing over OTT or MSO provided content received through the access point device 2.

The connection 10 between the access point device 2 and the client device 4 can be implemented through a wireless connection that operates in accordance with, but is not limited to, any IEEE 802.11 protocols. Additionally, the connection 10 between the access point device 2 and the client device 4 can also be implemented through a WAN, a LAN, a VPN, MANs, PANs, WLANs, SANs, a DOCSIS network, a fiber optics network (e.g., FTTH, FTTX, or HFC), a PSDN, a global Telex network, or a 2G, 3G, 4G or 5G network, for example. Connection 10 can carry information associated with an asset.

The connection 10 can also be implemented using a wireless connection in accordance with Bluetooth protocols, BLE, or other short range protocols that operate in accordance with a wireless technology standard for exchanging data over short distances using any licensed or unlicensed band such as the CBRS band, 2.4 GHz bands, 5 GHz bands, 6 GHz or 60 GHz bands. One or more of the connections 10 can also be a wired Ethernet connection.

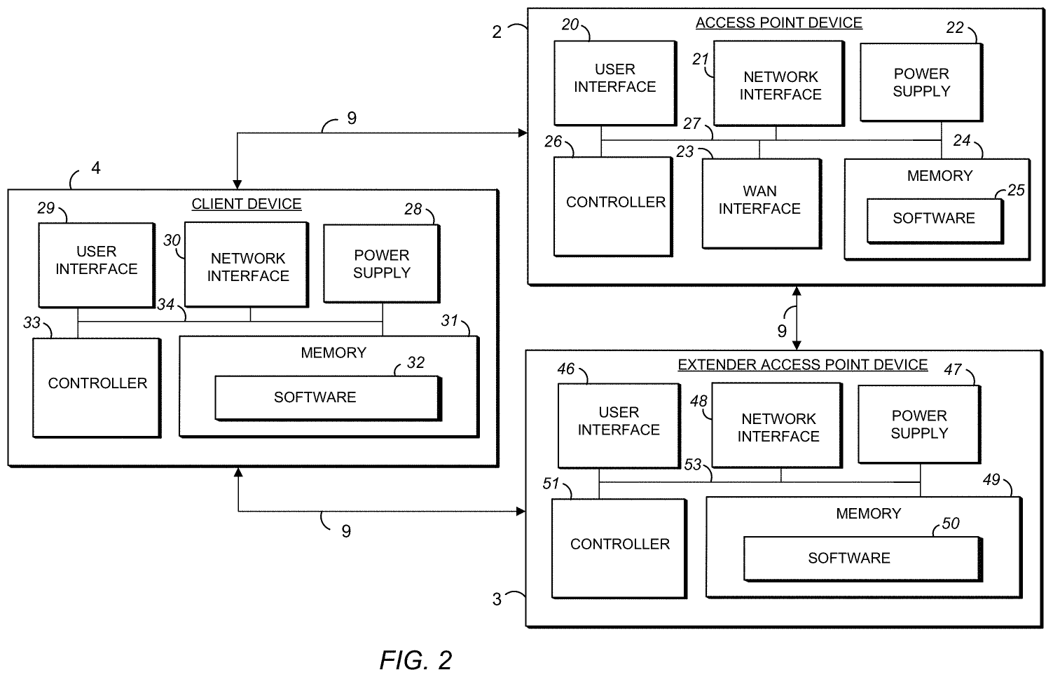

A detailed description of the exemplary internal components of the access point device 2, the extender access point devices 3, and the client devices 4 shown in FIG. 1 will be provided in the discussion of FIG. 2. However, in general, it is contemplated by the present disclosure that the access point device 2, the extender access point devices 3, and the client devices 4 include electronic components or electronic computing devices operable to receive, transmit, process, store, and/or manage data and information associated with the system 100, which encompasses any suitable processing device adapted to perform computing tasks consistent with the execution of computer-readable instructions stored in a memory or a computer-readable recording medium (e.g., a non-transitory computer-readable medium).

Further, any, all, or some of the computing components in the access point device 2, the extender access point devices 3, and the client devices 4 may be adapted to execute any operating system, including Linux, UNIX, Windows, MacOS, DOS, and ChromOS as well as virtual machines adapted to virtualize execution of a particular operating system, including customized and proprietary operating systems. The access point device 2, the extender access point devices 3, and the client devices 4 are further equipped with components to facilitate communication with other computing devices over the one or more network connections to local and wide area networks, wireless and wired networks, public and private networks, and any other communication network enabling communication in the system 100.

FIG. 2 is a more detailed block diagram illustrating various components of an exemplary access point device, client device, and wireless extender access point device implemented in the system of FIG. 1, according to some example embodiments.

Although FIG. 2 only shows one extender access point device 3 and one client device 4, the extender access point device 3 and the client device 4 shown in the figure are meant to be representative of the other extender access point devices 3 and client devices 4 of a network system, for example, system 100 shown in FIG. 1. Similarly, the connections 9 between the access point device 2, the extender access point device 3, and the client device 4 shown in FIG. 2 are meant to be exemplary connections and are not meant to indicate all possible connections between the access point devices 2, extender access point devices 3, and client devices 4. Additionally, it is contemplated by the present disclosure that the number of access point devices 2, extender access point devices 3, and client devices 4 is not limited to the number of access point devices 2, extender access point devices 3, and client devices 4 shown in FIGS. 1 and 2.

Now referring to FIG. 2 (e.g., from left to right), the client device 4 can be, for example, any device as discussed with reference to FIG. 1, including, but not limited to, a computer, a portable device, an electronic tablet, an e-reader, a PDA, a mobile phone such as a smart phone, a smart speaker, an IoT device, an iControl device, a portable music player with smart capabilities capable of connecting to the Internet, cellular networks, and interconnecting with other devices via Wi-Fi and Bluetooth, or other wireless hand-held consumer electronic device capable of executing and displaying the content received through the access point device 2. Additionally, the client device 4 can be a TV, an IP/QAM STB, or an SMD that is capable of decoding audio/video content, and playing over OTT or MSO provided content received through the access point device 2.

As shown in FIG. 2, the client device 4 includes a power supply 28, a user interface 29, a network interface 30, a memory 31, and a controller 33.

The power supply 28 supplies power to the internal components of the client device 4 through the internal bus 34. The power supply 28 can be a self-contained power source such as a battery pack with an interface to be powered through an electrical charger connected to an outlet (e.g., either directly or by way of another device). The power supply 28 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The user interface 29 includes, but is not limited to, any of a biometric scanning device, push buttons, a camera, a keyboard, a keypad, a liquid crystal display (LCD), a thin film transistor (TFT), a light-emitting diode (LED), a high definition (HD) or other similar display device including a display device having touch screen capabilities so as to allow interaction between one or more users and the client device 4, or a combination thereof. For example, the client device 4 may be used or shared at various times by multiple users. In one or more embodiments, the user interface 29 includes a biometric scanning device that scans for any one or more biometrics of a user of the client device 4 including, but not limited to, devices or applications that provide information or data associated with any of a facial pattern scan, a retinal scan, an iris scan, a thumbprint scan, any other biometric scan, or a combination thereof. In one or more embodiments, the user interface 29 may be external to the client device 4, for example, an external camera and/or scanner communicatively coupled to the client device 4.

The network interface 30 can include, but is not limited to, various network cards, interfaces, and circuitry implemented in software and/or hardware to enable communications with the access point device 2 and the extender access point device 3 using the communication protocols in accordance with connection 9 (e.g., as described with reference to FIG. 1). For example, the network interface 30 allows for communication between the client device 4 and an access control function of access point device 2 as discussed with reference to FIGS. 3, 4, 5A, 5B and 6. As shown, network interface card 30 allows for direct communication with access point device 2 and indirect communication with access point device 2 via expander access point device 3.

The memory 31 includes a single memory or one or more memories or memory locations that include, but are not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), a hard disk or any other various layers of memory hierarchy. The memory 31 can be used to store any type of instructions, software, or algorithms including software 32 for controlling the general function and operations of the client device 4 in accordance with the embodiments described in the present disclosure. In one or more embodiments, client device 4 is an electronic device shared between multiple users, and software 32 includes one or more applications and/or instructions for establishing a connection with the access point device 2 and the extender access point device 3 so as to access an asset via ISP 1.

The controller 33 controls the general operations of the client device 4 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 32 for controlling the operation and functions of the client device 4 in accordance with the embodiments described in the present disclosure. Communication between the components (e.g., 28-31 and 33) of the client device 4 may be established using an internal bus 34.

The extender access point device 3 can be, for example, any wireless hardware electronic device used to extend a wireless network by receiving the signals transmitted by the access point device 2 and rebroadcasting the signals to client devices 4, which may be out of range of the access point device 2 including, but not limited to, a wireless extender, a repeater, and/or an AP. The extender access point device 3 can also receive signals from any one or more of the client devices 4 and rebroadcast the signals to the access point device 2, mobile device 5, or any other one or more client devices 4.

As shown in FIG. 2, the extender access point device 3 includes a user interface 46, a power supply 47, a network interface 48, a memory 49, and a controller 51.

The user interface 46 can include, but is not limited to, push buttons, a keyboard, a keypad, an LCD, a TFT, an LED, an HD or other similar display device including a display device having touch screen capabilities so as to allow interaction between a user and the extender access point device 3.

The power supply 47 supplies power to the internal components of the wireless extender access point device 3 through the internal bus 53. The power supply 47 can be connected to an electrical outlet (e.g., either directly or by way of another device) via a cable or wire.

The network interface 48 can include various network cards, interfaces, and circuitry implemented in software and/or hardware to enable communications with the client device 4 and the access point device 2 using the communication protocols in accordance with connection 9 (e.g., as described with reference to FIG. 1). For example, the network interface 48 can include multiple radios or sets of radios (e.g., a 2.4 GHz radio, one or more 5 GHz radios, and/or a 6 GHz radio), which may also be referred to as wireless local area network (WLAN) interfaces. One radio or set of radios (e.g., 5 GHz and/or 6 GHz radio(s)) provides a BH connection between the wireless extender access point device 3 and the access point device 2, and optionally other wireless extender access point device(s) 3. Another radio or set of radios (e.g., 2.4 GHz, 5 GHz, and/or 6 GHz radio(s)) provides a fronthaul (FH) connection between the extender access point device 3 and one or more client device(s) 4.

The memory 49 can include a single memory or one or more memories or memory locations that include, but are not limited to, a RAM, a DRAM, a memory buffer, a hard drive, a database, an EPROM, an EEPROM, a ROM, a flash memory, logic blocks of an FPGA, hard disk or any other various layers of memory hierarchy. The memory 49 can be used to store any type of instructions, software, or algorithm including software 50 associated with controlling the general functions and operations of the wireless extender access point device 3 in accordance with the embodiments described in the present disclosure.

The controller 51 controls the general operations of the wireless extender access point device 3 and can include, but is not limited to, a CPU, a hardware microprocessor, a hardware processor, a multi-core processor, a single core processor, an FPGA, a microcontroller, an ASIC, a DSP, or other similar processing device capable of executing any type of instructions, algorithms, or software for controlling the operation and functions of the wireless extender access point device 3 in accordance with the embodiments described in the present disclosure. General communication between the components (e.g., 46-49 and 51) of the extender access point device 3 may be established using the internal bus 53.

The access point device 2 can be, for example, a hardware electronic device that can combine one or more functions of any of a modem, a gateway (for example, a residential gateway), an access point (AP), a router, or combinations thereof for providing an asset received from the asset provider via (ISP) 1 to network or wireless devices (e.g., extender access point devices 3, client devices 4) in the system, for example, system 100 of FIG. 1. It is also contemplated by the present disclosure that the access point device 2 can include the function of, but is not limited to, an IP/QAM STB or SMD that is capable of decoding audio/video content, and playing OTT or MSO provided content.

As shown in FIG. 2, the access point device 2 includes a user interface 20, a network interface 21, a power supply 22, a wide area network (WAN) interface 23, a memory 24, and a controller 26.

The user interface 20 can include, but is not limited to, push buttons, a keyboard, a keypad, an LCD, a TFT, an LED, an HD or other similar display device including a display device having touch screen capabilities so as to allow interaction between a user and the access point device 2.

The network interface 21 may include various network cards, and circuitry implemented in software and/or hardware to enable communications with the extender access point device 3 and the client device 4 using the communication protocols in accordance with connection 9 (e.g., as described with reference to FIG. 1). Additionally, the various network cards, interfaces, and circuitry of the network interface 21 enable communications with a client device 4 (e.g., a mobile device) using the one or more communication protocols in accordance with connection 10 (e.g., as described with reference to FIG. 1). For example, the network interface 21 can include an Ethernet port (also referred to as a LAN interface) and multiple radios or sets of radios (e.g., a 2.4 GHz radio, one or more 5 GHz radios, and/or a 6 GHz radio, also referred to as WLAN interfaces). One radio or set of radios (e.g., 5 GHz and/or 6 GHz radio(s)) provides a backhaul (BH) connection between the access point device 2 and the wireless extender access point device(s) 3. Another radio or set of radios (e.g., 2.4 GHz, 5 GHz, and/or 6 GHz radio(s)) provides a FH connection between the access point device 2 and one or more client devices 4.

The power supply 22 supplies power to the internal components of the access point device 2 through the internal bus 27. The power supply 22 can be connected to an electrical outlet (e.g., either directly or by way of another device) via a cable or wire.

The wide area network (WAN) interface 23 may include various network cards, and circuitry implemented in software and/or hardware to enable communications between the access point device 2 and the ISP 1 using the wired and/or wireless protocols in accordance with connection 13 (e.g., as described with reference to FIG. 1).

The memory 24 includes a single memory or one or more memories or memory locations that include, but are not limited to, a RAM, a DRAM, a memory buffer, a hard drive, a database, an EPROM, an EEPROM, a ROM, a flash memory, logic blocks of a FPGA, hard disk or any other various layers of memory hierarchy. The memory 24 can be a non-transitory computer-readable storage medium used to store any type of instructions, software, or algorithm including software 25 for controlling the general functions and operations of the access point device 2 and performing management functions related to the other devices (wireless extender access point devices 3 and client devices 4) in the network in accordance with the embodiments described in the present disclosure (e.g., including a dynamic channel selection function according to some example embodiments of the present disclosure).

The controller 26 controls the general operations of the access point device 2 as well as performs management functions related to the other devices (wireless extender access point devices 3 and client device 4) in the network. The controller 26 can include, but is not limited to, a central processing unit (CPU), a network controller, a hardware microprocessor, a hardware processor, a multi-core processor, a single core processor, a FPGA, a microcontroller, an ASIC, a DSP, or other similar processing device capable of executing any type of instructions, algorithms, or software including the software 25 for controlling the operation and functions of the access point device 2 in accordance with the embodiments described in the present disclosure including, but not limited to, an access control function to control access to one or more assets by the client device 4. Communication between the components (e.g., 20-24, and 26) of the access point device 2 may be established using the internal bus 27. The controller 26 may also be referred to as a processor, generally.

FIG. 3 is a more detailed block diagram illustrating certain components of an exemplary access point device implemented in the system of FIGS. 1 and 2, according to some example embodiments.

As shown in FIG. 3, the access point device 2 includes the network interface 21, the memory 24, and the controller (processor) 26.

The network interface 21 includes an Ethernet port 103 (e.g., a wired LAN interface), a 2.4 GHz radio 104 and a 5 GHz radio 105 (e.g., wireless LAN interfaces, or WLAN interfaces). The access point device 2 may communicate with the local area network devices (e.g., the extender access point devices 3, the client devices 4) of a system, for example, system 100 of FIG. 1, via one or more of the Ethernet port 103, the 2.4 GHz radio 104, and/or the 5 GHz radio 105. However, some other example embodiments of inventive concepts of the present disclosure are not limited to these interfaces only (e.g., the techniques may be applied with a 6 GHz radio or other similar future developed technologies). As mentioned above, according to aspects of the present disclosure, one radio or set of radios can operate as a BH radio to provide a BH connection between the access point device 2 and the wireless extender access point device(s) 3, while another radio or set of radios can provide a FH connection between the access point device 2 and the client device(s) 4.

The memory 24 includes an access control function 200 and a central repository 300. The access control function 200 may be implemented as part of the instructions, algorithms, or software including the software 25 described above with reference to FIG. 2. The central repository 300 may be implemented as a database, a structure, a flat-file system or any other repository or storage system for storing data and/or information for use, for example, by the access control function 200. While central repository 300 is shown as a local repository, part of memory 24, the present disclosure contemplates that central repository 300 can be remote from the access point device 2. In one or more embodiments, the access control function 200 when executed requests a scan of a user, compares the received user scan to one or more previously stored user scans (for example, one or more user scans stored in a central repository 300), determines whether the user scan matches to a stored user scan, and if a user match is determined then controls access to the requested asset by the user based on a list of one or more assets (for example, a list of assets stored in central repositor 300) associated with the user.

The controller 26 includes a processor that is configured to access the memory 24, perform the access control function 200 (e.g., via execution of the software 25) and communicate with ISP 1 to receive one or more assets. The processor of the controller 26 also controls communications with the network or wireless devices (e.g., the wireless extender access point devices 3, the client devices 4) via the Ethernet port 103, the 2.4 GHz radio 104, and/or the 5 GHz radio 105 in accordance with embodiments described in the present disclosure.

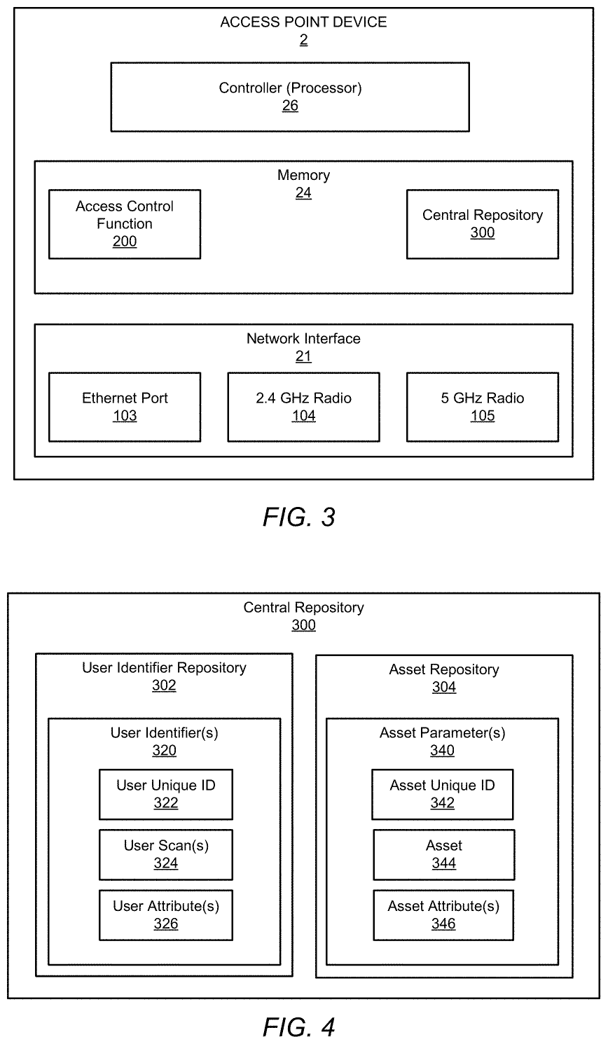

FIG. 4 is a detailed block diagram of a central repository for storing one or more elements (for example, data and/or information) used by an access control function, for example, access control function 200 of FIG. 3, according to an embodiment of the present disclosure.

Central repository 300 can include, but is not limited to, any of a database, a structure, a flat-file system, a table, a list such as a linked-list, any other repository or storage system, or a combination thereof. Central repository 300 stores and/or maintains, for example, data and/or information required for use by the access control function 200 so as to control access to one or more assets requested by a user of a client device 4. In one or more embodiments, central repository 300 includes a user identifier repository 302 and an asset repository 304. While user identifier repository 302 and asset repository 304 are shown as separate elements, each may be part of a single repository, a plurality of repositories, a local repository, a remote repository, or any combination thereof. For example, user identifier repository 302 may be a first table of the central repository 300 while asset repository 304 may be a second table of the central repository 300.

The user identifier repository 302 can include data and/or information associated with one or more users of any one or more client devices 4 of a network system, for example, a home network environment such as the system 100 of FIG. 1. The user identifier repository 300 can include one or more user identifiers 320 including, but not limited to, any of a user unique identifier (ID) 322, a user scan 324, one or more user attributes 326, any other user data/information, or a combination thereof.

The user unique ID 322 can include a unique identifier for a particular user so as to distinguish a particular user from one or more other users. The user unique ID 320 can be a randomly or automatically generated value such as by a random number generated value or number, set by a user, or by any other method or combination thereof.

The user scan 324 can be associated with a user unique ID 322. The user scan 324 can include data and/or information associated with a scan of a particular user for example, a user with a user unique ID 322. For example, the user scan 324 can include biometric data from any of a facial pattern scan, a retinal scan, an iris scan, a thumbprint scan, any other biometric scan, or a combination thereof. The user scan 324 can include, but is not limited to, a file such as an image file, a data file, and/or a pointer to data/information stored on a storage medium that is stored locally to or remotely from the access point device 2 such as a hard drive, a memory, a database, a cloud resource or any other storage medium. The user scan 324 distinguishes each user requesting access to an asset based on, for example, biometric data that is unique to and/or can be used to distinguish the associated user. For example, the access control function 200 can compare a received scan from a user of a client device 4 and compare that scan to one or more user scans 324 to determine if any one or more associated user unique IDs 322, for example, are a match to the user associated with the received scan.

One or more user attributes 326 can be associated with a user unique ID 322 and/or a user scan 324. The one or more user attributes 326 can be used to determine the one or more assets 344 available to the user and/or when such assets are available to the corresponding user. The one or more user attributes 326 can include, but are not limited to, any of a user age, a user date range, a user time range, a user session duration, an asset identifier (for example, an asset unique ID 342, an asset 344, or both) or a combination thereof. A user age can include a chronological age of a user, any number and/or rating representing an age of a user (for example, a parental guide rating, a Motion Picture Associate of America (MPAA) rating, a TV rating, an age-appropriateness rating, any other rating, or a combination thereof), a representation of an age range, any other identifier indicative of age of a user, or any combination thereof. A user date range can include a range of dates or a single date for which a user, for example, a user associated with a user unique ID 322 or a user scan 324, has access to an asset, for example, access control for a user to an asset can be based on a defined date range. Similarly, a user time range can include a range of times or a single time that a user for example, a user associated with a user unique ID 322 or a user scan 324, has access to an asset 344, for example, access control for a user to an asset 344 can be based on time of day with access limited or blocked during certain times while allowed during other times. As an example, a child user may be blocked from access to an asset 344 after a certain time of night until a certain time in the morning but otherwise allowed access to the asset 344. However, an adult user can be given unlimited access to the asset 344, for example, by setting the user date range and/or the user time range to a NULL value or any other value indicative of unlimited access. The user session duration can indicate a length of time or duration of a user's session. For example, one user may be permitted a long duration for a session to access an asset (for example, an adult user) while another user will be permitted a short duration for a session to access an asset (for example, a child user) based on the user session duration associated with the particular user. The duration of a session can be measured in seconds, hours, data rate or any other measure of time. In one or more embodiments, the user session duration may be determined based on the user age or any other user attribute 326 such that a user session duration need not be a separate user attribute 326. An asset identifier can indicate the one or more assets (for example, a list of assets) that the corresponding user has permission or is allowed to access.

In one or more embodiments, the user identifier repository 302 can include one or more elements as indicated in Table 1. As indicated in Table 1, a user with a user unique ID 322 of 101 (referred to as user 101) has an associated user scan 324 indicated as “filename_101.file” that includes biometric data/information that is unique or otherwise identifies/distinguishes user 101. User 101 has associated user attributes 326 that, for example, indicate that user 101 is an adult without any restrictions (indicated as “NULL” in Table 1) to access any asset other than user age. As indicated in Table 1, a user with a user unique ID 322 of 102 (referred to as user 102) has an associated user scan 324 indicated as “filename_102.file” that includes biometric data/information that is unique or otherwise identifies/distinguishes user 102. User 102 has associated user attributes 326 that, for example, indicate that user 102 is a child with access restrictions as to age, date (for example, only Saturday and Sunday access), time (for example, only 9:00 AM to 8:00 PM access) and asset (for example, only Internet Browser access). While Table 1, illustrates an example embodiment, the disclosure contemplates various iterations, omissions, additions and combinations of the elements of Table 1.

TABLE 1

| User Unique ID 322 | User Scan 324 | User Attribute (s) 326 |
|---|---|---|
| 101 | filename_101.file | User Age = 18 |
| | | User Date Range = NULL |
| | | User Time Range = NULL |
| | | Asset Identifier = NULL |
| 102 | filename_102.file | User Age = 12 |
| | | User Date Range = Weekends |
| | | User Time Range = 0900-2000 |
| | | Asset Identifier = Internet Browser |

The asset repository 304 can include data and/or information associated with one or more assets 344 accessible by any one or more users of any one or more client devices 4 of a network system, for example, a home network environment such as the system 100 of FIG. 1. Asset repository 304 can include one or more asset parameters 340 including, but not limited to, any of an asset unique ID 342, an asset 344, one or more asset attributes 346 associated with each asset 344, any other asset parameter, or a combination thereof. Each user of a client device 4, for example, each user unique ID 322 and/or user scan 324, can have an associated one or more asset parameters 340.

The asset unique ID 342 can include a unique identifier for each particular asset 344 and can be set or determined as described with reference to user unique ID 322. While asset unique ID 342 and user unique ID 322 are discussed, the present disclosure contemplates that neither, either, or both can be utilized in any one or more embodiments.

An asset 344 can include, but is not limited to, any of a content, an application and/or program, a device, any other data and/or information, or a combination thereof. For example, asset 344 can comprise content associated with a uniform resource locator (URL) accessed via an Internet or web browser application and/or the URL. Each asset 344 can be associated with an asset unique ID and/or one or more asset attributes 346. In one or more embodiments, asset 344 is a list of assets associated with a particular user, for example, a user unique ID 322 and/or a user scan 324.

The one or more asset attributes 346 are one or more attributes associated with an asset 344 including, but not limited to, any of an asset age, an asset date range, an asset time range, or a combination thereof. The asset age is similar to the user age such that the asset age is indicative of a user age required for access to the associated asset. For example, an Internet or web browser or a particular URL can be an asset 344 that has one or more associated asset attributes 346 such as an asset age of eighteen years old such that for a user to have access to the asset the corresponding user age must be at or above eighteen years old. The asset date range can include a single date or a range of dates that an associated asset 344 is accessible, blocked, limited or controlled any other access control type. The asset time range can include a single time or range of times that an associated asset 344 is accessible, blocked, limited or controlled by any other access control type.

In one or more embodiments, the one or more user identifiers 320 can include identification of an asset 344 and associated one or more asset attributes for a particular user unique ID 322 such that the asset repository 304 is not required. In one or more embodiments, any of the one or more user identifiers 320, the one or more asset parameters 340, or a combination thereof can be included in a single repository, such as a table of a database or a list.

In one or more embodiments, the asset repository 304 can include one or more elements as indicated in Table 2. As indicated in Table 2, an asset 344 with an asset unique ID 342 of 201 (referred to as asset 201) where the associated asset 344 is indicated as a “Internet Browser” (for example, an application for accessing the Internet) with the associated asset attributes 346 of an asset age of twelve years old, an asset date range of NULL and an asset time range of NULL. As indicated in Table 2, another asset 344 with an asset unique ID 342 of 202 where the associated asset 344 is indicated as a “www.URL” (for example, a website accessible via an Internet Browser) with the associated asset attributes 346 of an asset age of eighteen years old, an asset date range of M-F (indicative of Monday through Friday) and an asset time range of “0800-1700” (for example, 8:00 AM to 5:00 PM). Referring back to Table 1, user 101 can access the asset 201 and the asset 202 on any date and at any time while user 102 can access asset 201 (as asset 201 is a URL accessible via an Internet or web browser) only on the weekends between the hours of 9:00 AM and 8:00 PM and cannot access asset 202. While Table 2, illustrates an example embodiment, the disclosure contemplates various iterations, omissions, additions and combinations of the elements of Table 2. While the example discussed contemplates that the one or more user attributes 326 list permissible attributes, the one or more user attributes 326 can also list non-permissible attributes. For example, an asset identifier of “Internet Browser” can indicate that the user 102 does not have permission to access an Internet Browser and therefore cannot be granted access to any URL. Additionally, the one or more user attributes 326 can be represented as one or more thresholds.

TABLE 2

| Asset Unique ID 342 | Asset 344 | Asset Attribute(s) 346 |
|---|---|---|
| 201 | Internet | Asset Age = 12 |
| | Browser | Asset Date Range = NULL |
| | | Asset Time Range = NULL |
| 202 | www.URL | Asset Age = 18 |
| | | Asset Date Range = M-F |
| | | Asset Time Range = 0800-1700 |

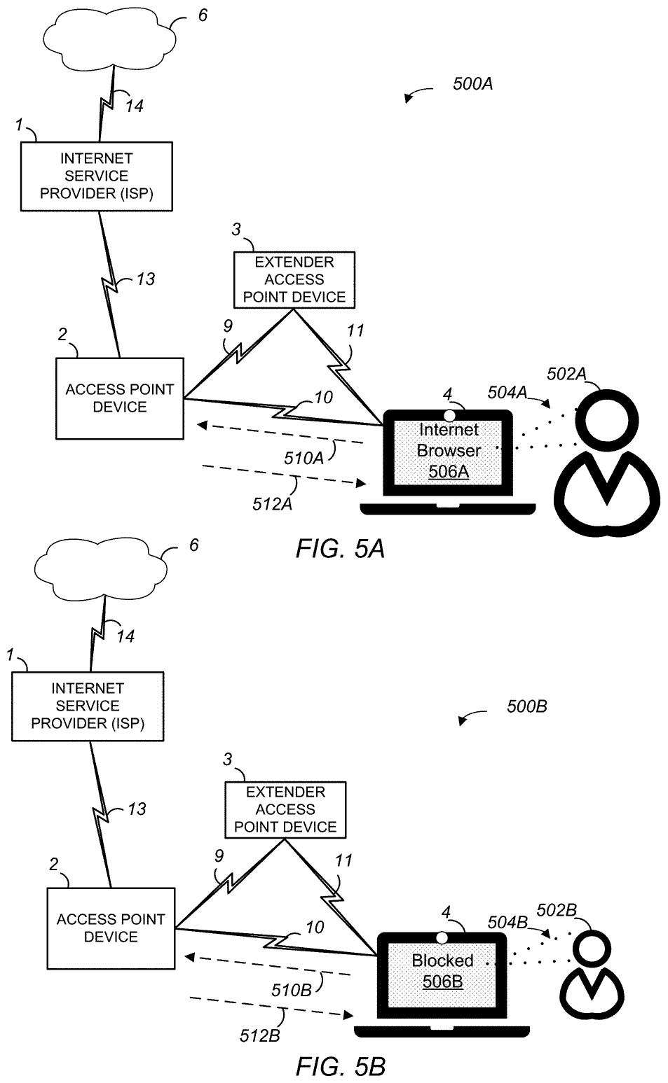

FIGS. 5A and 5B are detailed block diagrams of an access control system, according to an embodiment of the present disclosure. FIG. 5A is an example home network environment 500A similar to system 100 of FIG. 1. Home network environment 500A includes a user 502A, for example, an adult user such as adult user 101 of Table 1. A connection can be established between client device 4 and the access point device 2 via connection 10 and/or connections 11 and 9. User 502A utilizes a client device 4 to access an asset 506A, for example, content viewable via an Internet browser, retrieved from ISP 1. As shown in FIG. 5A, user 502A is granted or allowed access to the requested asset, for example, access to an asset 201 based on the one or more asset attributes 346.

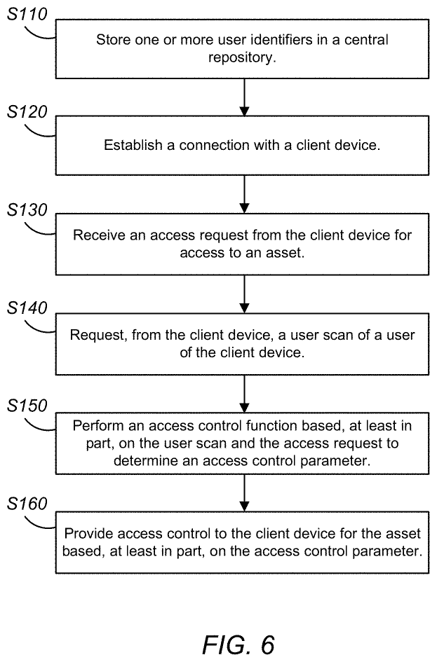

In one example, user 502A utilizes client device 4 to send an access request 510A over connection 10 to access point device 2 for access to an asset 506A. The access request 510A can include any one or more parameters indicative of the requested asset 506A. In response to the access request 510A, the access point device 2 sends a scan request 512A over connection 10 to the client device 4 to perform a scan 504A of user 502A. The client device 2 sends scan 504A to the access point device 2 over connection 10. The access point device 2 receives the scan 504A and executes an access control function (for example, access control function 200 of FIG. 2 and discussed in more detail with reference to FIG. 6). The access control function 200 based, at least in part, on the received scan 504A and the access request 510A, determines an access control parameter. The access control parameter can be indicative of the type of access control, for example, the access control parameter can indicate that the user 502A should be blocked from access to the asset 506A, granted access to asset 506A, have limited access, or any other type of access control type to asset 506A. Based, at least in part, on the access control parameter, the access point device 2 provides access control to the client device. In the example of FIG. 5A, the user 502A access control parameter is indicative of granting or allowing access. In FIG. 5A, the user 502A is permitted granted access to view or utilize the asset 506A.

FIG. 5B is an example home network environment 500B similar to system 100 of FIG. 1 and home network environment 500A of FIG. 5A. Typically, in a home network environment 500B multiple users as well as multiple types of users can access the same client device 4, for example, user 502A (for example, an adult user) and user 502B (for example, a child user). In FIG. 5B, the user 502B (for example, child user 102 in Table 1) utilizes the same client device 4 utilized by user 502A in FIG. 5A. Similar to the discussion with reference to FIG. 5A, the user 502B utilizes client device 4 to send an access request 510B over connection 10 to the access point device 2 for access to an asset 506B, for example, asset 202 in Table 2. The access request 510B can include any one or more parameters indicative of the requested asset 506B. In response to the access request 510B, the access point device 2 sends a scan request 512B over connection 10 to the client device 4 to perform a scan 504B of user 502B. The client device 4 sends the scan 504B to the access point device 2 over connection 10. The access point device 2 receives the scan 504B and executes the access control function 200 based, at least in part, on the received scan 504B and the access request 510B to determine an access control parameter. Based on the access control parameter, access to the asset 506B is blocked for the user 502B as user 502B, for example, user 502B does not meet the asset age as indicated in Tables 1 and 2.

While FIGS. 5A and 5B illustrate communications between the client device 4 and the access point device 2 via connection 10, the present disclosure contemplates that such communications can occur indirectly to the access point device via connection 11 to extender access point 3 and connection 9 from the extender access point 3 to the access point device 2.

Problems can occur when an asset is accessed by a non-authorized or unattended user. For example, multiple users of a client device 4 may have different authorizations or access controls for any one or more assets. A first user of a client device 4 (for example, an adult) can have full authorization or access to certain assets while a second user of the client device 4 (for example, a child) can have limited or no access to any one or more assets. In addition, each user of a system, for example, system 100 of FIG. 1, can utilize multiple client devices 4 making it difficult to control access for each user at each client device 4. Therefore, there is a need to provide a centralized access control (for example, by the access point device 2) for one or more assets according to criteria associated with various users of each individual client device 4 connected to an access point device 2 in a system so as to reduce or eliminate the need to monitor and configure multiple client devices 4 used by the various users. For example, the novel solution eliminates the requirement of a configuration of a user profile for each user on each client device 4 connected to a network is not required as access control is centralized at the access point device 2.

FIG. 6 is a flow chart illustrating a method for providing at an access point device access control of an asset by a user of a client device, according to one or embodiments of the present disclosure.

An access point device 2, for example, of a system 100, may be programmed with one or more instructions (e.g., software 25 stored in memory 24) to perform access control function 200 in one or more example embodiments. In FIG. 6, it is assumed that the devices and/or elements include their respective controllers and their respective software stored in their respective memories, as discussed above in connection with FIGS. 2-4, which when executed by their respective controllers perform the functions and operations in accordance with one or more embodiments of the present disclosure (e.g., including performing a access control function 200).

The access point device 2 comprises a controller 26 that executes one or more computer-readable instructions, stored on a memory 24, that when executed perform one or more of the operations of steps S110-S160. In one or more embodiments, the one or more instructions can be one or more software or applications, for example, one or more software 25 that includes access control function 200. While the steps S110-S160 are presented in a certain order, the present disclosure contemplates that any one or more steps can be performed simultaneously, substantially simultaneously, repeatedly, in any order or not at all (omitted).

At step S110, one or more user identifiers are stored in a central repository, for example, one or more user identifiers 320 can be stored in a central repository 300 of access point device 2 such as stored in a user identifier repository 302 as discussed with reference to FIGS. 3 and 4. The central repository 300 or user identifier repository 302 can be local to or remote from the access point device 3.

At step S120, the access point device 2 establishes a connection with a client device 4. For example, a residential gateway can establish a connection with a laptop via a wireless network connection. The access point device 2 can utilize any one or more communication protocols to establish a connection with the client device 4. The connection provides the client device 4 with access to one or more assets, for example, content from the Internet 6.

At step S130, the access point device 2 receives an access request from the client device 4 for access to an asset. For example, the client device 4 can send an access request that identifies one or more assets 344 requested for access by a user of the client device 4 as discussed with reference to FIGS. 5A-5B. A first user of the client device 4, for example, can request a first asset via a first access request while using the client device 4 while a second user of the same client device 4 can request a second asset via a second access request while using the same client device 4. Any number of users can have access to client device 4 and each user can make any number of access requests for one or more various assets 344.

At step S140, the access point device 2 requests, from the client device 4, a user scan of a user of the client device 4. The user can be any user of client device 4, for example, as discussed with reference to FIGS. 5A-5B. The user scan can be any type of scan that includes data or information that identifies the user of the client device 4 that has requested access to the asset. The user scan can be in any type of format, for example, any one or more user scans discussed with reference to FIG. 4 including but not limited to a user scan that comprises any of a facial pattern, a thumbprint, a retinal scan, an iris scan, or a combination thereof.

At step S150, the access point device 2 performs an access control function 200 based, at least in part, on the user scan and the access request to determine an access control parameter. The access control function 200 can include a software or an application stored local to (for example, software 25) or remote from the access control function 200, for example, as discussed with reference to FIGS. 3, 4, 5A and 5B.

For example, the access control function 200 can determine that a first user has an associated first user unique ID 322 based on a comparison of the received user scan from client device 4 to one or more user scans 324. When a match of the received user scan to one of the one or more user scans 324 so as to identify the first user scan 324 or associated first user unique ID 322, the access control function can determine or identify one or more first user attributes 326 associated with the first user unique ID 322 or first user scan 324. The first user can be an adult indicated by a first user age of a first user attribute 326 (for example, a first user age of at least 18 or age value indicative of the age of the user such as “adult” or “child”). The first user can make an access request for a first asset 344 that has an associated first asset attribute 346 where the first asset attribute 346 includes a first asset age (for example, an asset age of 18 years old or an asset age threshold). The asset control function 200 can compare the first asset age and the first user age to determine that that the first user should be provided access to the first asset 344, for example, the asset control function 200 can determine an access control parameter that indicates that the first user is allowed or granted access to the requested first asset 344.

Similarly, a second user can have a second user unique ID 322 associated with a second user scan 324 and one or more second user attributes 326. The second user can be a child as indicated by a second user age of a second user attribute 326 (for example, a second user age of 12 or age threshold). The second user can request a second asset 344 that has an associated second asset attribute 346 where the second asset attribute 346 includes a second asset age (for example, an asset age of 12 years old or an asset age threshold). The asset control function 200 can compare the second asset age to determine that the second user should be provided access to the second asset 244. However, if the second user sends an access request to the asset point device 2 to access the first asset 344, the access control function 200 will determine that the access control parameter should indicate that the second user is denied access to or blocked from accessing the first asset 344 as the second user has a second user age that is below a threshold or first asset age required to access the first asset 344.

As discussed above, the access control function 200 can also determine access to a requested asset by a user based on a list of assets associated with the user corresponding to the user scan.

At step S160, the access point device 2 provides access control to the client device for the requested asset based, at least in part, on the determined access control parameter. For example, the access control parameter can indicate that the client device 2 should be blocked and/or denied access or allowed and/or granted access to the requested asset.

In one or more embodiments, a client device 4 may be an electronic device programmed with one or more instructions (e.g., software or application 32) to perform steps for initiating and establishing a BH connection between an access point device 2 and/or an expander device 3 so as to control access to one or more asset by a user of the client device 4. In FIG. 6, it is assumed that the devices include their respective controllers and their respective software stored in their respective memories, as discussed above in reference to FIGS. 1-4, which when executed by their respective controllers perform the functions and operations in accordance with the example embodiments of the present disclosure (e.g., including performing a access control function 200).

According to some example embodiments of inventive concepts disclosed herein, there are provided novel solutions for access control to one or more assets by an access point device to a client device utilizing an asset control function of the access point device. In addition, there is provided a centralized repository to store and/or maintain information and/or data for use by the asset control function where the centralized repository can be local to or remote from the access point device. The novel solutions according to example embodiments of inventive concepts disclosed herein provide features that enhance the network environment of, for example, a home/residential network gateway (GW), wireless access points (Wi-Fi APs), Home Network Controller (HNC), wireless routers, mesh networking nodes (e.g., Wi-Fi EasyMesh systems), and the like, by providing access control to one or more assets by various users of a client device.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. An access point device for providing access control to a client device, the access point device comprising:
a memory storing one or more computer-readable instructions;
a processor configured to execute the one or more computer-readable instructions to:
establish a connection with the client device;
receive an access request from the client device for access to an asset;
request, from the client device, a user scan of a user of the client device;
perform an access control function based, at least in part, on the user scan and the access request to determine an access control parameter; and
provide access control to the client device for the asset based, at least in part, on the access control parameter.

2. The access point device of claim 1, wherein the processor is further configured to execute the one or more computer-readable instructions to:
store one or more user identifiers in a central repository, wherein at least one of the one or more user identifiers is associated with the user.

3. The access point device of claim 1, wherein the performing the access control function comprises:
identifying a user match by comparing the user scan to one or more user identifiers in a central repository; and
determining the access control parameter based, at least in part, on comparing one or more user identifiers associated with the user match and one or more asset parameters associated with the asset.

4. The access point device of claim 3, wherein:
the one or more user identifiers comprise one or more user attributes, and wherein the one or more user attributes comprise any of a user age, a user date range, a user time range, or a combination thereof; and
the one or more asset parameters comprise one or more asset attributes, and wherein the one or more asset attributes comprise any of an asset age, an asset date range, an asset time range, or a combination thereof.

5. The access point device of claim 4, wherein:
the one or more user attributes is the user age of the user, the asset is the content associated with an Internet uniform resource locator (URL) and the one or more asset attributes is the asset age; and
the comparing the one or more user identifiers associated with the user match and the one or more asset parameters associated with the asset comprises determining if the user age is at, above or both the asset age.

6. The access point device of claim 1, wherein the providing access control comprises:
blocking the client device from accessing the asset; or
allowing the client device to access the asset.

7. The access point device of claim 1, wherein the user scan comprises any of a facial pattern scan, a thumbprint scan, a retinal scan, an iris scan, or a combination thereof.

8. A method for an access point device to provide access control to a client device, the method comprising:
establishing a connection with the client device;
receiving an access request from the client device for access to an asset;
requesting, from the client device, a user scan of a user of the client device;
performing an access control function based, at least in part, on the user scan and the access request to determine an access control parameter; and
providing access control to the client device for the asset based, at least in part, on the access control parameter.

9. The method of claim 8, further comprising:
storing one or more user identifiers in a central repository, wherein at least one of the one or more user identifiers is associated with the user.

10. The method of claim 8, wherein the performing the access control function comprises:
identifying a user match by comparing the user scan to one or more user identifiers in a central repository; and
determining the access control parameter based, at least in part, on comparing one or more user identifiers associated with the user match and one or more asset parameters associated with the asset.

11. The method of claim 10, wherein:
the one or more user identifiers comprise one or more user attributes, and wherein the one or more user attributes comprise any of a user age, a user date range, a user time range, or a combination thereof; and
the one or more asset parameters comprise one or more asset attributes, and wherein the one or more asset attributes comprise any of an asset age, an asset date range, an asset time range, or a combination thereof.

12. The method of claim 11, wherein:
the one or more user attributes is the user age of the user, the asset is the content associated with an Internet uniform resource locator (URL) and the one or more asset attributes is the asset age; and
the comparing the one or more user identifiers associated with the user match and the one or more asset parameters associated with the asset comprises determining if the user age is at, above or both the asset age.

13. The method of claim 8, wherein the providing access control comprises:
blocking the client device from accessing the asset; or
allowing the client device to access the asset.

14. The method of claim 8, wherein the user scan comprises any of a facial pattern scan, a thumbprint scan, a retinal scan, an iris scan, or a combination thereof.

15. A non-transitory computer-readable medium of an access control device for storing a program for providing access control to a client device, which when executed by a processor of the access point device, causes the access point device to perform one or more operations comprising:
establishing a connection with the client device;
receiving an access request from the client device for access to an asset;
requesting, from the client device, a user scan of a user of the client device;
performing an access control function based, at least in part, on the user scan and the access request to determine an access control parameter; and
providing access control to the client device for the asset based, at least in part, on the access control parameter.

16. The computer-readable medium of claim 15, wherein the program when executed by the processor, further causes the access point device to perform one or more further operations comprising:
storing one or more user identifiers in a central repository, wherein at least one of the one or more user identifiers is associated with the user.

17. The computer-readable medium of claim 15, wherein the performing the access control function comprises:
identifying a user match by comparing the user scan to one or more user identifiers in a central repository; and
determining the access control parameter based, at least in part, on comparing one or more user identifiers associated with the user match and one or more asset parameters associated with the asset.

18. The computer-readable medium of claim 17, wherein:
the one or more user identifiers comprise one or more user attributes, and wherein the one or more user attributes comprise any of a user age, a user date range, a user time range, or a combination thereof; and
the one or more asset parameters comprise one or more asset attributes, and wherein the one or more asset attributes comprise any of an asset age, an asset date range, an asset time range, or a combination thereof.

19. The computer-readable medium of claim 18, wherein:
the one or more user attributes is the user age of the user, the asset is the content associated with an Internet uniform resource locator (URL) and the one or more asset attributes is the asset age;
the comparing the one or more user identifiers associated with the user match and the one or more asset parameters associated with the asset comprises determining if the user age is at, above or both the asset age.

20. The computer-readable medium of claim 15, wherein the user scan comprises any of a facial pattern scan, a thumbprint scan, a retinal scan, an iris scan, or a combination thereof.
